(19) United States
(12) Patent Application Publication
(10) Pub. No.: US 2012/0307291 A1
(43) Pub. Date: Dec. 6, 2012

(54) CONFIGURATION OF PRINT JOBS BASED ON PRINTER STATE

(75) Inventors: Richard Blanchard, JR., Sonoma, CA (US); David Gelphman, Aptos, CA (US); Howard A. Miller, Saratoga, CA (US); Todd W. Ritland, San Francisco, CA (US)

(73) Assignee: APPLE INC., Cupertino, CA (US)

(21) Appl. No.: 13/298,809

(22) Filed: Nov. 17, 2011

Related U.S. Application Data
(60) Provisional application No. 61/493,494, filed on Jun. 5, 2011.

(51) Int. Cl. G06K 15/02

(52) U.S. Cl. 358/1.15

(57) ABSTRACT

The disclosed embodiments provide a system that performs a print job. During operation, the system obtains a printing context for the print job, including a content type associated with the print job. Next, the system obtains a current state of a printer. The system then automatically sets one or more job options for the print job based on the printing context and the current state of the printer, wherein the one or more job options include a media size a border size and/or a media type. Finally, the system sends the print job to the printer.

### RELATED APPLICATION

This application hereby claims priority under 35 U.S.C. §119 to U.S. Provisional Application No. 61/493,494, entitled “Configuration of Print Jobs Based on Printer State,” by Richard Blanchard, Jr., David Gelphman, Howard A. Miller and Todd W. Ritland, filed 5 Jun. 2011 (Atty. Docket No.: APL-P10896USP1).

### BACKGROUND

1. Field

The present embodiments relate to printers for computer systems. More specifically, the present embodiments relate to techniques for configuring print jobs based on the current states of printers used to execute the print jobs.

2. Related Art

Printing may facilitate a variety of personal and/or business activities. For example, documents may be printed within a business for design, marketing, accounting, review, recordkeeping, planning, and/or notification purposes. Similarly, a user may print pictures and/or greeting cards for display and/or sharing with friends, family, and/or acquaintances.

However, different types of print settings and/or printer capabilities may be required to produce optimal print output for various types of digital media. For example, a word-processing document may be printed on a laser printer in black-and-white to enhance the readability and/or sharpness of text in the word-processing document. On the other hand, the resolution and/or color gamut of a color photo may be emphasized by printing the color photo on glossy paper using a dye-sublimation printer.

Hence, what is needed is a mechanism for using print settings and/or printer capabilities to enhance print output for various types of digital media.

### SUMMARY

The disclosed embodiments provide a system that performs a print job. During operation, the system obtains a printing context for the print job, including a content type associated with the print job. Next, the system obtains a current state of a printer. The system then automatically sets one or more job options for the print job based on the printing context and the current state of the printer, wherein the one or more job options include a media size, a border size, or a media type. Finally, the system sends the print job to the printer, where the print job is executed using the printer.

In some embodiments, the printing context also includes a regional setting. For example, the regional setting may be a language setting and/or a location.

In some embodiments, the current state of the printer includes at least one of an available media size, an available border size, an available media type, an available paper tray, an available output bin, an available ink set, an available toner, an available dye, an available ribbon, an available stapler, and an available hole punch.

In some embodiments, the one or more job options further include at least one of a paper tray, an output bin, an ink set, a toner, a dye, a ribbon, stapling and hole punching.

In some embodiments, sending the print job to the printer involves:
(i) providing the media size and the border size to the application;
(ii) obtaining, from the application, print data for the print job based on the media size and the border size; and
(iii) sending the print data and the one or more job options to the printer.

In some embodiments, the content type is at least one of an image, a document, and black-and-white content.

In some embodiments, the one or more job options for the image include at least one of a glossy media type and an extended-gamut ink set.

In some embodiments, the one or more job options for the black-and-white content include a black-and-white ink set.

### BRIEF DESCRIPTION OF THE FIGURES

FIG. 1 shows a printing system in accordance with an embodiment.

FIG. 2 shows a system for performing a print job in accordance with an embodiment.

FIG. 3 shows a flowchart illustrating the process of performing a print job in accordance with an embodiment.

FIG. 4 shows a flowchart illustrating the process of sending a print job to a printer in accordance with an embodiment.

FIG. 5 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for performing a print job. The print job may include print data and/or one or more job options associated with the print data. The print job may be created by a print server and/or other device with functionality to communicate with a printer. After the print job is created, the print server may send the print job to the printer, and the printer may execute the print job by outputting the print data onto sheets of paper according to the job options in the print job.

More specifically, the disclosed embodiments provide a method and system for automatically configuring the print job based on the current state of the printer to which the print job is sent. First, a printing context for the print job may be obtained from an application, an operating system and/or a device associated with the print job. The printing context may include a content type that specifies the type of digital media (e.g., image, document, black-and-white content) to be printed using the print job, as well as a regional setting (e.g., language setting, location) associated with the application or an associated operating system and/or device. Next, the current state of the printer may be obtained. The current state of the printer may include an available media size, an available border size, an available media type, an available paper tray, an available output bin, an available ink set, an available toner, an available dye, an available ribbon, an available stapler and/or an available hole punch. In other words, the current state may correspond to a set of resources that is currently available on the printer.

One or more job options for the print job may then be automatically set based on the printing context and/or current state of the printer. For example, a media size and border size for the print job may be set based on one or more available media and/or border sizes in the printer, the content type associated with the print job, and/or the regional settings. Similarly, a media type for the print job may be set based on one or more available media types in the printer and/or the content type associated with the print job. Finally, the print job may be sent to the printer, where the print job is executed by the printer.

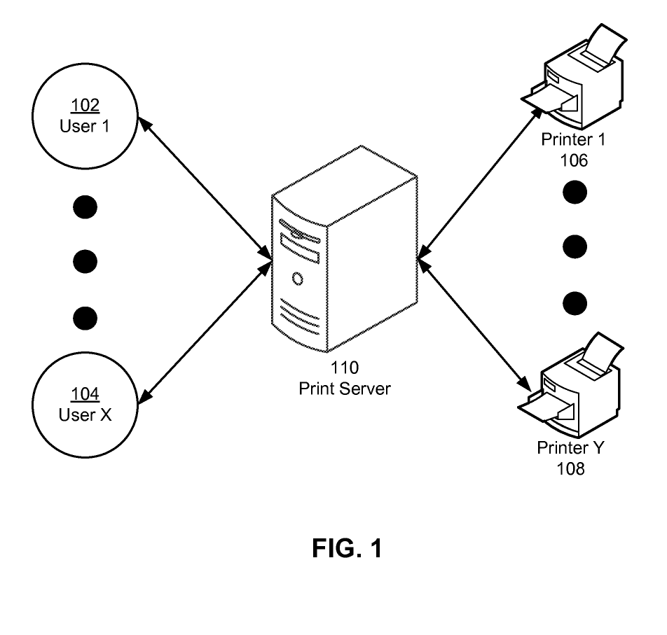

FIG. 1 shows a printing system in accordance with an embodiment. As shown in FIG. 1, the printing system includes a print server 110 and one or more printers (e.g., printer 1 106, printer y 108) connected to print server 110. The printers may correspond to network printers that are connected to print server 110 using a wired or wireless network connection. Alternatively, one or more printers may connect to print server 110 and/or other print servers in the printing system as local peripherals using one or more printer cables and/or one or more ports (e.g., parallel ports, serial ports, Universal Serial Bus (USB) ports).

Print server 110 may process and configure requests for print jobs from one or more users (e.g., user 1 102, user x 104). The users may be associated with access rights to one or more printers connected to print server 110. For example, the users may be associated with user accounts that enable use of one or more printers connected to print server 110.

Upon receiving a request for a print job, print server 110 may send the request to the appropriate printer, which executes the print job using settings provided by the user requesting the print job. For example, the user may select a document and/or image to be printed and one or more job options associated with printing the document and/or image. The job options may include a number of copies, a number of printing sides (e.g., single- or double-sided), collation, stapling, hole punching, an ink set (e.g., black-and-white, color), a toner, a dye, a ribbon, a border size (e.g., bordered, borderless), a media size (e.g., A4, letter), a media type (e.g., glossy, matte, bond, colored), a paper tray, an output bin, a resolution and/or print quality (e.g., low, medium, high), a page orientation, and/or a printing range (e.g., page range, selection).

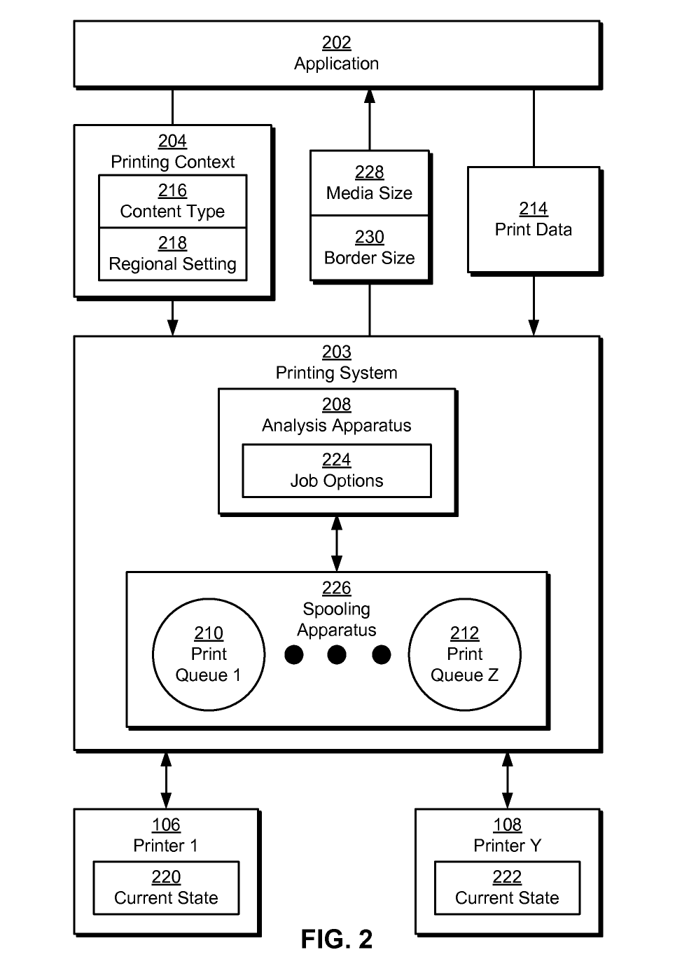

Conversely, print server 110 and/or other components in the printing system may include functionality to automatically configure one or more job options for the print job based on the current state of the printer used to execute the print job. As discussed in further detail below with respect to FIG. 2, printing system 203 associated with print server 110 may obtain a printing context for the print job from an application, an operating system associated with the application, and/or a device on which the application executes. (Note that printing system 203 generally includes all printing related code which resides outside of an application, including code within print server 110 and code within a device that the application runs on.) The printing context may include a content type associated with the print job and/or a regional setting associated with an associated operating system or device. Printing system 203 may also obtain a current state of a printer in the printing system by, for example, querying the printer for the current state. The current state may include an available media size, an available border size, an available media type, an available paper tray, an available output bin, an available ink set, an available toner, an available dye, an available ribbon, an available stapler, and/or an available hole punch.

Next, printing system 203 may automatically set one or more job options for the print job based on the printing context and the current state of the printer. The job options may include a media size, a border size, a media type, a paper tray, an output bin, an ink set, an available toner, an available dye, an available ribbon, an available stapler, and/or an available hole punch. For example, printing system 203 may enhance the appearance of a color image by configuring a print job for the image with a glossy media type and/or an extended gamut ink set, if such a configuration is supported by the available resources in the printer. On the other hand, printing system 203 may configure a print job for a black-and-white image with a black-and-white ink set to increase the tonal and/or dynamic range of print output for the black-and-white image.

Finally, printing system 203 may send the print job to the printer. In particular, printing system 203 may provide the media size and border size from the job options to the application, and the application may generate print data for the print job based on the media size and border size. Afterward, printing system 203 may obtain the print data from the application and send the print data and the job option(s) to the printer. Finally, the print job may be executed using the printer. As a result, printing system 203 may utilize the available resources and/or current state of the printer to dynamically optimize a print job for a particular printing context.

FIG. 2 shows a system for performing a print job in accordance with an embodiment. As described above, the system includes printing system 203 and/or other components (e.g., computer systems, print servers) associated with printing system 203.

In addition, an application 202 may be configured to communicate with printing system 203. For example, application 202 may execute on a laptop computer, personal computer, mobile phone, tablet computer, and/or other network-enabled electronic device. In turn, application 202 may communicate with printing system 203 using an application programming interface (API) provided by printing system 203 over HyperText Transfer Protocol (HTTP), Internet Printing Protocol (IPP), Line Printer Daemon (LPD) protocol, and/or another network protocol associated with communication in a printing system.

In particular, application 202 and printing system 203 may enable the printing of digital media. For example, application 202 may provide a user interface (e.g., graphical user interface (GUI)) that allows a user to select one or more documents, images, and/or other files to be included in a print job. Alternatively, application 202 may perform batch-processing operations that create and schedule print jobs in the printing system with little to no user intervention.

After a print job is created, application 202 may send the print job to printing system 203, where the print job is placed into a print queue (e.g., print queue 1 210, print queue z 212) by a spooling apparatus 226. For example, spooling apparatus 226 may assign the print job to a specific printer (e.g., printer 1 106, printer y 108) by placing the print job in the print queue for the printer. When printing system 203 subsequently determines that the printer is not busy, printing system 203 may send the print job to the printer. Alternatively, spooling apparatus 226 may place the print job into a print queue for a printing pool containing multiple physical printers. Once printing system 203 sees that a printer in the printing pool meeting certain criteria is available, printing system 203 may send the print job to the printer. Note the printer can be selected from the printing pool based on the load, availability, current states 220-222, and/or other attributes of printers in the printing pool.

As mentioned above, printing system 203 may use current states 220-222 of the printers to automatically configure print jobs from application 202. First, printing system 203 may obtain a printing context 204 for each print job from application 202. Conversely, some or all of printing context 204 may be obtained from an operating system and/or device associated with application 202 and/or the print job. Printing context 204 may include a content type 216 associated with the print job. Content type 216 may specify the type of digital media to be printed using the print job. For example, content type 216 may correspond to an image, a document, and/or black-and-white content.

Printing context 204 may also include a regional setting 218. Regional setting 218 may provide location-based information related to application 202, an associated operating system, an associated device, and/or the print job. For example, regional setting 218 may include a language setting for the user interface of application 202 and/or a location of an associated device, as provided by a user of application 202 and/or a positioning system (e.g., Global

Positioning System) associated with the device on which application 202 is hosted. Alternatively, regional setting 218 may correspond to a geographic region to which the device is set and may be unrelated to the language setting for the user interface of application 202.

Next, printing system 203 may obtain a current state (e.g., current states 220-222) of a printer in the printing system. For example, the printer may be selected by the user, application 202, and/or printing system 203 to execute the print job based on load, availability, current states 220-222, and/or other attributes associated with the printer. Printing system 203 may then identify the selected printer and obtain the printer's current state by requesting the current state from the printer.

In one or more embodiments, the current state of the printer includes an available media size, an available border size, an available media type, an available paper tray, an available output bin, an available ink set, an available toner, an available dye, an available ribbon, an available stapler, and/or an available hole punch. For example, the printer may include available media sizes (e.g., paper sizes) of 4×6, 8½×11, and A4; bordered and borderless printing; a glossy media type for the 4×6 media size and a matte media type for the remaining media sizes; three available paper trays containing the three different sizes and/or types of media; two available output bins; and one available stapler. In other words, the current state of the printer may include resources that are currently available on the printer. (Note that the term “available” as used in this specification and appended claims indicates that the associated resource is presently loaded into the printer and available for use without human intervention.)

Printing context 204 and the available resources (e.g., current state) may then be used by an analysis apparatus 208 in printing system 203 to automatically set one or more job options 224 for the print job. For example, analysis apparatus 208 may facilitate execution of the print job by selecting job options 224 that are both appropriate for printing context 204 and enabled by the current state of the printer used to execute the print job.

In one or more embodiments, job options 224 include a media size 228 (e.g., paper size), a border size 230, and/or media type (e.g., paper type) for the print job. Moreover, analysis apparatus 208 may set media size 228, border size 230, and the media type based on the currently available combinations of media sizes, border sizes, and media types in the printer. For example, the printer may support bordered and borderless printing and include glossy 5×7 paper, glossy 8½×11 paper, and matte A4 paper. Analysis apparatus 208 may set job options 224 to borderless printing and glossy 5×7 paper for an image content type (e.g., content type 216) that is normally printed without borders using glossy 4×6 paper because glossy 4×6 paper is not available in the printer. In addition, analysis apparatus 208 may specify the matte A4 paper in job options 224 for a document content type that is normally printed on 8½×11 paper because the matte media type is preferred over the glossy media type for printing the document content type. In other words, analysis apparatus 208 may compare the available combinations of media sizes, border sizes, and media types with an ordered list of preferred media sizes and/or media types for printing context 204. Analysis apparatus 208 may then set job options 224 to the available combination of media size 228, border size 230, and/or media type that corresponds to the highest ranked media size and/or media type on the list.

Analysis apparatus 208 may also include functionality to set other job options 224, including a paper tray, an output bin, an ink set, a toner, a dye, a ribbon, stapling and hole punching. For example, analysis apparatus 208 may rotate among different output bins in the printer to physically separate print output for different print jobs from one another. Furthermore, analysis apparatus 208 may specify an extended gamut ink set for printing of color images, a black-and-white ink set for printing of black-and-white content, and/or a black ink set for printing of black-and-white documents. Finally, analysis apparatus 208 may specify stapling if multiple copies of a large document are to be printed.

Once job options 224 are set, printing system 203 may provide media size 228 and border size 230 to application 202, and application 202 may generate print data 214 for the print job based on media size 228 and border size 230. For example, application 202 may correspond to a web browser that formats a webpage using dimensions provided by media size 228 and/or border size 230 and saves the formatted webpage to a Portable Document Format (PDF) file corresponding to print data 214. Printing system 203 may subsequently obtain print data 214 and send print data 214 and job options 224 to the printer (e.g., through spooling apparatus 226) to enable execution of the print job by the printer. As a result, printing system 203 may utilize the current state of the printer to enhance the print output of the print job. Moreover, such enhancement may occur independently of knowledge of the printer by application 202. In other words, the system of FIG. 2 may facilitate the optimization of print output for a variety of applications and/or types of digital media, regardless of the print-related functionality of each of the applications.

Those skilled in the art will appreciate that the system of FIG. 2 may be implemented in a variety of ways. For example, components of application 202 and printing system 203 may reside on the same device (e.g., computer system, electronic device, etc.), or components of application 202 and printing system 203 may execute on different devices and communicate over a network connection. Similarly, analysis apparatus 208 and spooling apparatus 226 may be implemented by the same component and/or different components in printing system 203. In addition, printing system 203 may include functionality to communicate with multiple print servers to enable the processing of print jobs by different sets of printers connected to the print servers.

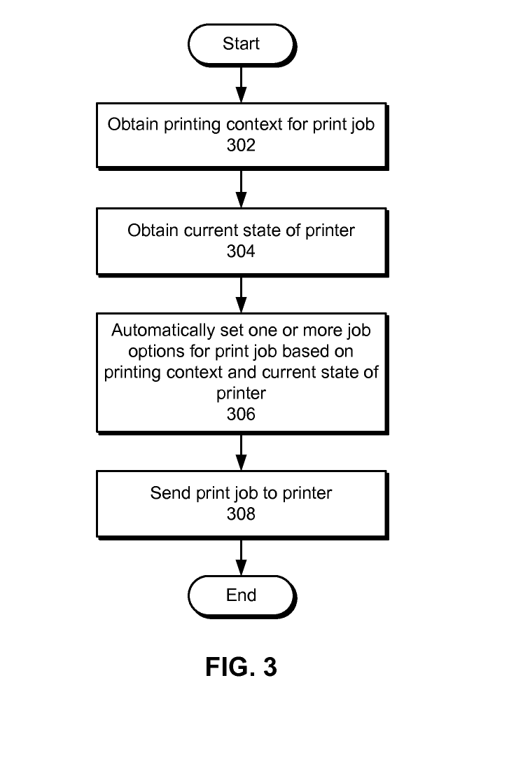

FIG. 3 shows a flowchart illustrating the process of performing a print job in accordance with an embodiment. In one or more embodiments, one or more of the steps may be omitted, repeated, and/or performed in a different order. Accordingly, the specific arrangement of steps shown in FIG. 3 should not be construed as limiting the scope of the technique.

Initially, a printing context for the print job is obtained from an application, an associated operating system and/or an associated device (operation 302). The application may be used to generate the printing context and/or request the print job. The printing context may specify a content type associated with the print job, such as a document, image, and/or black-and-white content. The printing context may also specify a regional setting associated with the application, the operating system and/or the device, such as a language setting and/or a location.

Next, a current state of a printer is obtained (operation 304). For example, the current state may be obtained by querying the printer for the current state and receiving the current state over a network connection with the printer. The current state may include an available media size, an available border size, an available media type, an available paper tray, an available output bin, an available ink set, an available toner, an available dye, an available ribbon, an available stapler, and/or an available hole punch.

One or more job options for the print job are set based on the printing context and the current state of the printer (operation 306). The job options may specify a media size, a border size and/or media type for the print job. For example, the job options may specify just the media type if only one media size is available in the printer. Conversely, the job options may specify a combination of a media size and a media type if multiple media sizes and media types are available in the printer. The job options may also include a border size, a paper tray, an output bin, an ink set, a toner, a dye, a ribbon, stapling and/or hole punching. For example, job options for a color image may include a glossy media type and/or an extended gamut ink set, while job options for black-and-white content may include a black-and-white ink set.

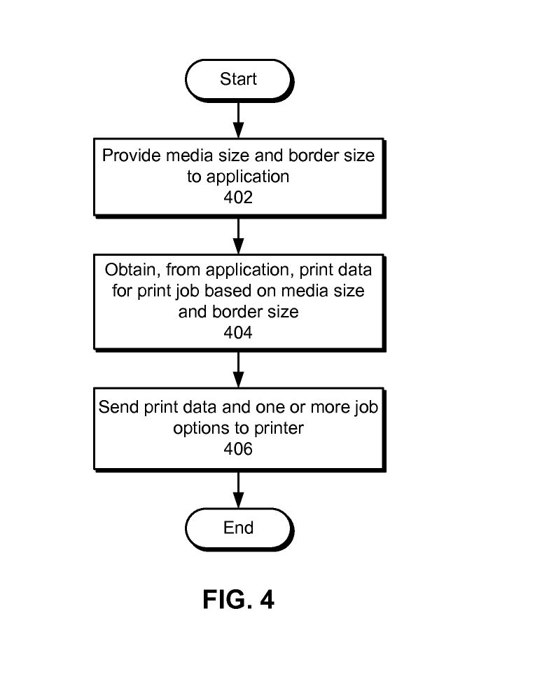

Finally, the print job is sent to the printer (operation 308). For example, the print job may be placed in a print queue for the printer to be subsequently sent to the printer once the printer is ready to start the print job. The sending of print jobs to printers is discussed in further detail below with respect to FIG. 4.

FIG. 4 shows a flowchart illustrating the process of sending a print job to a printer in accordance with an embodiment. In one or more embodiments, one or more of the steps may be omitted, repeated, and/or performed in a different order. Accordingly, the specific arrangement of steps shown in FIG. 4 should not be construed as limiting the scope of the technique.

First, a media size and border size are provided to an application (operation 402). The media size and border size may be selected from a set of available media sizes and/or border sizes for the printer. For example, the media size may be 4×6, 5×7, 8½×11, A4, and/or 11×13, while the border size may correspond to bordered or borderless printing. Next, print data for the print job based on the media size and a border size is obtained from the application (operation 404). For example, the application may generate the print data by laying out an image and/or document within the dimensions specified by the media size and the border size. Finally, the print data and one or more job options for the print job are sent to the printer (operation 406) for execution of the print job. The print data and/or job options may utilize the current state of the printer to enhance the print output of the print job.

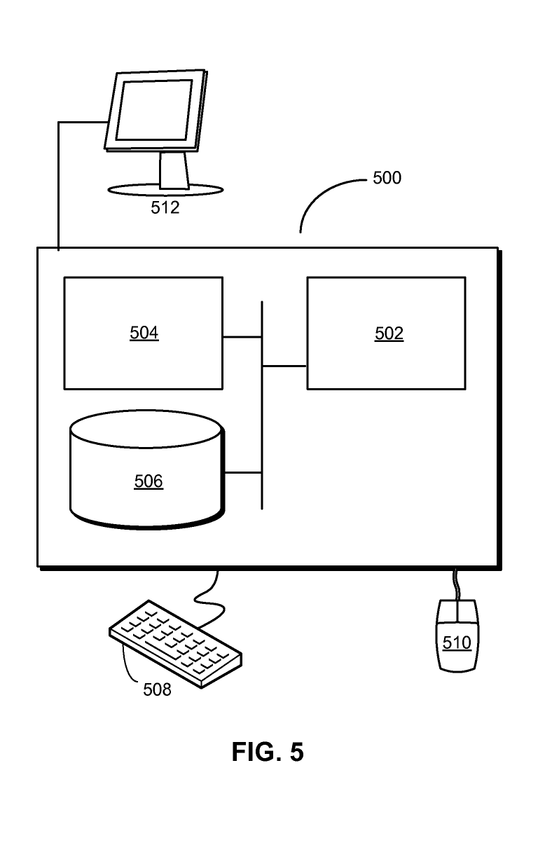

FIG. 5 shows a computer system 500 in accordance with an embodiment. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for performing a print job. The system may include an analysis apparatus that obtains, from an application (or an associated operating system or device), a printing context for the print job, including a content type associated with the print job. The analysis apparatus may also obtain a current state of a printer. The analysis apparatus may then automatically set one or more job options for the print job, including a media size, a border size and/or a media type, based on the printing context and the current state of the printer. The system may also include a spooling apparatus that sends the print job to the printer, where the print job is executed using the printer.

In addition, one or more components of computer system 500 may be remotely located and connected to the other components over a network. Portions of the present embodiments (e.g., analysis apparatus, spooling apparatus, etc.) may also be located on different nodes of a distributed system that implements the embodiments. For example, the present embodiments may be implemented using a cloud computing system that manages the use of a set of remote printers by a set of users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for performing a print job, comprising:
obtaining a printing context for the print job, wherein the printing context comprises a content type associated with the print job;
obtaining a current state of a printer;
automatically setting one or more job options for the print job based on the printing context and the current state of the printer, wherein the one or more job options comprise a media size, a border size, and/or a media type; and
sending the print job to the printer, wherein the print job is executed using the printer.

2. The computer-implemented method of claim 1, wherein the printing context further comprises a regional setting.

3. The computer-implemented method of claim 2, wherein the regional setting is at least one of a language setting and a location.

4. The computer-implemented method of claim 1, wherein the current state of the printer comprises at least one of an available media size, an available border size, an available media type, an available paper tray, an available output bin, an available ink set, an available toner, an available dye, an available ribbon, an available stapler, and an available hole punch.

5. The computer-implemented method of claim 1, wherein the one or more job options further comprise at least one of a paper tray, an output bin, an ink set, a toner, a dye, a ribbon, stapling and hole punching.

6. The computer-implemented method of claim 1, wherein sending the print job to the printer involves:
providing the media size and the border size to the application;
obtaining, from the application, print data for the print job based on the media size and the border size; and
sending the print data and the one or more job options to the printer.

7. The computer-implemented method of claim 1, wherein the content type is at least one of an image, a document, and black-and-white content.

8. The computer-implemented method of claim 7, wherein the one or more job options for the image comprise at least one of a glossy media type and an extended-gamut ink set.

9. The computer-implemented method of claim 7, wherein the one or more job options for the black-and-white content comprise a black-and-white ink set.

10. A system for performing a print job, comprising:
an analysis apparatus configured to:
obtain a printing context for the print job, wherein the printing context comprises a content type associated with the print job;
obtain a current state of the printer; and
automatically set one or more job options for the print job based on the printing context and the current state of the printer, wherein the one or more job options comprise a media size, a border size, and/or a media type; and
a spooling apparatus configured to send the print job to the printer, wherein the print job is executed using the printer.

11. The system of claim 10, wherein the printing context further comprises a regional setting.

12. The system of claim 10, wherein the current state of the printer comprises at least one of an available media size, an available border size, an available media type, an available paper tray, an available output bin, an available ink set, an available toner, an available dye, an available ribbon, an available stapler, and an available hole punch.

13. The system of claim 10, wherein the one or more job options further comprise at least one of a paper tray, an output bin, an ink set, a toner, a dye, a ribbon, stapling and hole punching.

14. The system of claim 10, wherein sending the print job to the printer involves:
providing the media size and the border size to the application;
obtaining, from the application, print data for the print job based on the media size and the border size; and
sending the print data and the one or more job options to the printer.

15. The system of claim 10, wherein the content type is at least one of an image, a document, and black-and-white content.

16. The system of claim 15, wherein the one or more job options for the image comprise at least one of a glossy media type and an extended-gamut ink set.

17. The system of claim 15, wherein the one or more job options for the document comprise a matte media type.

18. A computer-readable storage medium storing instructions that when executed by a computer cause the computer to perform a method for performing a print job, the method comprising:
obtaining a printing context for the print job, wherein the printing context comprises a content type associated with the print job;
obtaining a current state of the printer;
automatically setting one or more job options for the print job based on the printing context and the current state of the printer, wherein the one or more job options comprise a media size, a border size, and/or a media type; and
sending the print job to the printer, wherein the print job is executed using the printer.

19. The computer-readable storage medium of claim 18, wherein the printing context further comprises a regional setting.

20. The computer-readable storage medium of claim 18, wherein the current state of the printer comprises at least one of an available media size, an available border size, an available media type, an available paper tray, an available output bin, an available ink set, an available toner, an available dye, an available ribbon, an available stapler, and an available hole punch.

21. The computer-readable storage medium of claim 18, wherein the one or more job options further comprise at least one of a paper tray, an output bin, an ink set, a toner, a dye, a ribbon, stapling and hole-punching.

22. The computer-readable storage medium of claim 18, wherein sending the print job to the printer involves:
providing the media size and the border size to the application;
obtaining, from the application, print data for the print job based on the media size and the border size; and
sending the print data and the one or more job options to the printer.

23. The computer-readable storage medium of claim 18, wherein the content type is at least one of an image, a document, and black-and-white content.

24. The computer-readable storage medium of claim 23, wherein the one or more job options for the image comprise at least one of a glossy media type and an extended-gamut ink set.

25. The computer-readable storage medium of claim 23, wherein the one or more job options for the black-and-white content comprise a black-and-white ink set.
